(19) United States
(12) Patent Application Publication
(10) Pub. No.: US 2025/0128930 A1
(43) Pub. Date: Apr. 24, 2025

(54) SOLAR TABLE MOBILE TRANSPORT WITH COLLAPSIBLE MANIPULATORS

(71) Applicant: Terabase Energy, Inc., Berkeley, CA (US)

(72) Inventors: Adam Hansel, Davis, CA (US); Brian Coleman, Portland, OR (US); Soren Jensen, Corte Madera, CA (US)

(73) Assignee: Terabase Energy, Inc., Berkeley, CA (US)

(21) Appl. No.: 18/381,363

(22) Filed: Oct. 18, 2023

(51) Int. Cl. B66F 9/18; B66F 9/065; H02S 40/00

(52) U.S. Cl. CPC B66F 9/18; B66F 9/065; H02S 40/00

(57) ABSTRACT

Embodiments of a solar table mobile transport with collapsible manipulators are described. The collapsible manipulators may be scissor lifts, direct lifts, or pivot lifts, that couple to a torque tube of the solar table and provide at least vertical movement of the solar table. Once the mobile transport approaches an installation spot between installation piles, the mobile transport lifts the solar table by unfolding the collapsible manipulators such that that solar table may cross the pile line and the mobile transport can maneuver between the installation piles. The compactness of the mobile transport, especially when the collapsible manipulators are vertically installed, greatly enhances the maneuverability of the mobile transport within the limited space between the piles. Such a capability of mobile transport maneuverability in combination of solar table alignment facilitates an installation efficiency of the solar table.

### TECHNICAL FIELD

The present disclosure relates generally to a solar table manipulator with various maneuver capability for solar table movement. More particularly, the present disclosure relates to a solar table mobile transport with collapsible manipulators to move a solar table from a solar table assembly factory to an installation point, with maneuver capability for movement of the solar table.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is cost-effective management of the construction process and the ability to efficiently move components around the site during the construction process.

Large-scale solar panel systems typically include thousands of solar panels that are located across a multi-acre terrain and that are electrically coupled to provide a source of energy. These large-scale systems are oftentimes located in remote areas and require a significant investment in materials, resources and labor in their installation and design. The sourcing and delivery of materials and resources for these installations can be problematic and inconsistent. A further complication is the reliable and safe movement of these materials and resources across large areas of the construction site as well as maintaining consistent installation processes at each point of installation within the site. These issues further contribute to an increase in the cost and complexity of what is already a very cost-sensitive process.

FIG. 1 illustrates a typical prior-art installation process for solar systems. This prior-art installation process is implemented such that all mounting equipment for each solar panel is individually assembled and installed at its location within the larger system. The cost-effectiveness of this approach works fine within smaller solar deployments but struggles to cost-effectively scale to large solar systems as described below.

This traditional deployment 101 relies on materials being delivered to a deployment site via an access road. The materials are then processed and staged at the deployment site by a crew. A small portion of this delivered material is then moved by heavy equipment to a specific location where a solar panel and mounting equipment are assembled and installed at that location 102. The step is then repeated for an adjacent location 103 where materials are subsequently delivered, assembled and installed for a neighboring solar table within the system. While this approach may be effectively deployed in the installation of smaller solar systems, it becomes cost-prohibitive as the size of the system increases.

What is needed are systems, devices and methods that reduce the complexity and cost of the installation of large-scale solar panel systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 shows a prior art assembly and installation process of large-scale solar panel systems.

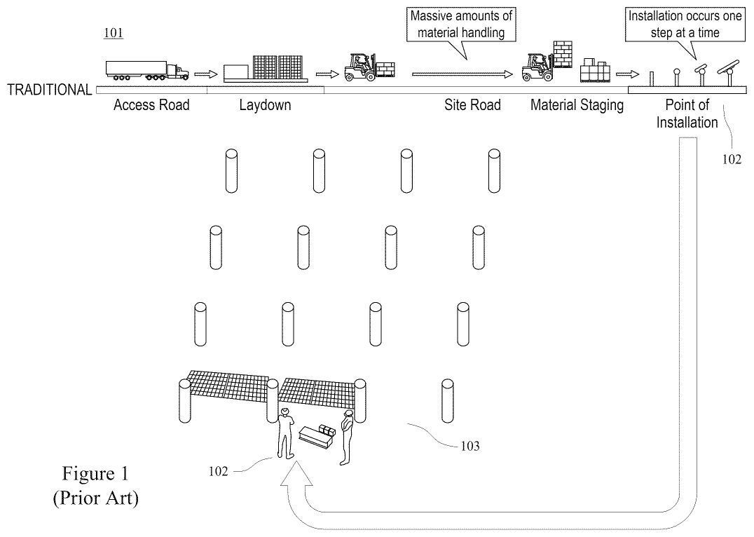

FIG. 2 is a diagram showing a centralized assembly and installation of a solar system including mobile transport of solar tables in accordance with various embodiments of the invention.

FIG. 3 is an exemplary sequence of diagrams illustrating an installation of a solar table within a solar system using a mobile transport according to various embodiments of the invention.

FIG. 4 is a perspective view of a solar table supported by multiple collapsible manipulators in a mobile transport according to various embodiments of the present invention.

FIG. 5 is a perspective view of a collapsible manipulator according to various embodiments of the invention.

FIG. 6 illustrates a perspective view of an alternative collapsible manipulator according to various embodiments of the invention.

FIG. 7 illustrates a perspective view of another alternative collapsible manipulator according to various embodiments of the invention.

FIG. 8 is a perspective view of a pair of pivot lifts on a mobile transport without a solar table load according to various embodiments of the present invention.

FIG. 9 is a perspective view of a pair of pivot lifts on a mobile transport with a solar table load according to various embodiments of the present invention.

FIG. 10 is a diagram illustrating a mobile transport maneuvering a solar table for installation according to various embodiments of the invention.

FIG. 11 is a diagram illustrating a mobile transport having a solar tabled aligned for installation according to various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of mechanical structures supporting corresponding functionalities of the solar table mobile transport.

Furthermore, connectivity between components or systems within the figures are not intended to be limited to direct connections. Also, components may be integrated together or be discrete prior to construction of a solar panel mobile transport.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functions may be optional; (2) components or functions may not be limited to the specific description set forth herein; (3) certain components or functions may be assembled/combined differently across different solar table mobile transports; and (4) certain functions may be performed concurrently or in sequence.

Furthermore, it shall be noted that many embodiments described herein are given in the context of the assembly and installation of large numbers of solar tables within a system, but one skilled in the art shall recognize that the teachings of the present disclosure may apply to other large and complex construction sites in which resources and personnel are difficult to manage and accurately predict. Additionally, embodiments of a solar table mobile transport may be implemented in smaller construction sites.

In this document, “large-scale solar system” refers to a solar system having 1000 or more solar panels. The word “resources” refers to material, parts, components, equipment or any other items used to construct a solar table and/or solar system. The word “personnel” refers to any laborer, worker, designer or individual employed to construct or install a solar table or solar system. The term “solar table” refers to a structural assembly comprising a torque tube and/or purlins with module rails. Some types of solar tables may have supplemental structure that allows it to connect to foundations/piles while other types do not have this supplemental structure. A solar table may have (but is not required) one or more solar panels and/or electrical harnesses. The term “solar table mobile transport” (hereinafter, “mobile transport”) describes a vehicle used to move a solar table to an installation site and facilitate an installation process of the solar table. A mobile transport may be driven by personnel, controlled by remote control or move autonomously within at least a portion of a solar system construction site. The term “transport component” refers to a lower portion of the mobile transport that provides movement and includes wheels (or similar features such as a tractor assembly or robotic system), steering mechanism (autonomous or personnel driven) and braking mechanism.

In this document, the term “collapsible manipulator” is a structure on a mobile transport to secure a solar table. The collapsible manipulator may be collapsed or deployed at a desirable position. The collapsible manipulator may provide alignment capability such that a torque tube and/or solar table may be moved in vertical, horizontal, and/or angular motions. In certain embodiments, the collapsible manipulator may enable or allow horizontal movement of the solar table within a horizontal range. The horizontal movement may be a manual or motorized motion. The term “motor” is defined as a structural device that produces motion, unidirectional or multidirectional, of a solar table. Examples of some motors may include elements such as actuators, tracks, etc. that help in producing motion of structures within the mobile transport or the solar table.

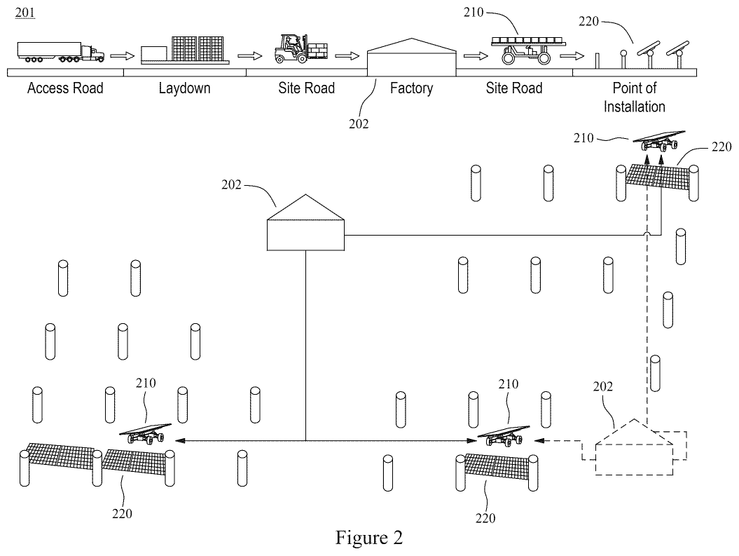

FIG. 2 provides an overview of a centralized solar table assembly and installation for large-scale solar systems according to various embodiments of the invention. Embodiments of the invention transition the prior art approach of assembly and installation at single location sites to a centralized and coordinated assembly factory that allows a more cost-effective and dynamic process of constructing large-scale solar systems. This centralized assembly of solar system components, such as solar tables, necessitates a more robust transport vehicle to move the pre-assembled components to the installation site. Additionally, the installation of these pre-assembled components may require functionality to support the alignment and integration of these components into the system. This alignment of a solar table secured on a mobile transport to a particular installation site is aided by horizontal and/or vertical motion via one or more collapsible manipulators.

Resources are brought to construction site 201 for a large-scale solar systems and initially processed. These resources are delivered to one or more assembly factories 202 where a coordinated and centralized solar table assembly process is performed. In certain embodiments, a construction site may have multiple centralized factories 202. As shown in FIG. 2, there are two centralized factories 202 strategically located at the site. The location and number of centralized factories 202 may depend on several parameters including the size of the site, the terrain of the site, the design of the site and other variables that relate to the construction of the large-scale solar system.

Assembled solar tables and equipment are moved from factory 202 to a point of installation 220 via motorized vehicles such as a mobile transport 210. In certain embodiments, the mobile transports are specifically designed to transport solar tables along a site road to the point of installation 220. As previously mentioned, the mobile transports 210 may be driven by personnel, may be controlled by remote control or autonomously driven by a computer system. The time and/or sequence in which solar tables are delivered to points of installation 220 may depend on a variety of factors that may be analyzed to configure a preferred schedule.

Delivery of an assembled solar table to an installation site requires an alignment process to securing points at the installation site. Because an assembled solar table is oftentimes large and heavy, this alignment process may be difficult and require significant effort by personnel to properly align both ends of a solar table to receptors, piles or other coupling elements at the installation site. Embodiments of the solar table mobile transport allow manual or motorized vertical/horizontal alignment of the solar table while it is still secured to the mobile transport. Specifically, the horizontal alignment capability also allows a less precise positioning of the mobile transport at the installation site due to the horizontal movement capability of the solar table. As a result, the mobile transport may be parked proximate to the installation site without requiring precise parking to initiate an alignment and installation process.

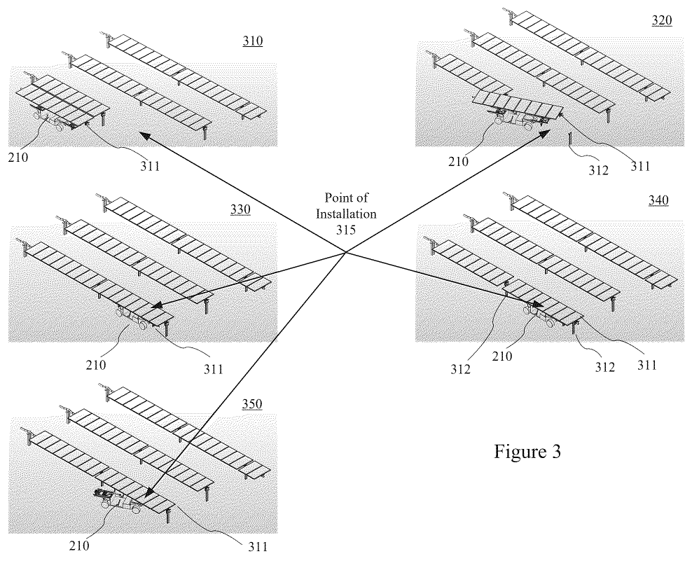

FIG. 3 illustrates a sequence of installation steps of a solar table at an installation site using a solar table mobile transport according to various embodiments of the invention. As shown in 310, a mobile transport 210 supporting a solar table 311 approaches a point of installation 315. The solar table 311 is secured to the mobile transport 210 by a solar table attachment component that securely holds the solar table above the mobile transport 210. In certain embodiments, the solar table 311 is assembled and secured to the attachment component at a centralized assembly factory and subsequently driven to the point of installation 315.

As shown in 320, the mobile transport 210 approaches the point of installation 315 in preparation for installation within the solar system. The point of installation 315 comprises structures used to secure the solar table 311 within the system. For example, a solar table 311 may be secured to a previously installed table whereby a torque tube in the solar table 311 is inserted into a previously installed table. The previously installed table may be secured to a pile 312 where threaded fasteners/rivets connect its bearing housing assembly/brackets to the pile 312. As shown in 330, the mobile transport 210 aligns the solar table 311 at the point of installation 315 for subsequent integration into solar system. This alignment process will be discussed in more detail below and includes alignment along a three-dimensional coordinate system as well as angular control of yaw, pitch and roll. As previously stated, horizontal movement capability on the mobile transport 210 allows for this alignment when the mobile transport 210 is located proximate to the installation site and does not require precise parking of the mobile transport relative to the location site.

As shown in 340, the solar table is secured within the solar system after alignment is completed. This securitization process includes attached the solar table 311 to piles 312 that lock the solar table in line with adjacent solar tables. One skilled in the art will recognize that other processes may be employed to securely lock a solar table 311 within the system and may use other components that replace or supplement the piles 312.

As shown in 350, mobile transport 210 detaches from the solar table 311 after an alignment process has occurred using horizontal, vertical and/or angular control as needed. The collapsible manipulator may be collapsed after the solar table 311 is secured within the system so that the mobile transport 210 may leave the point of installation 315.

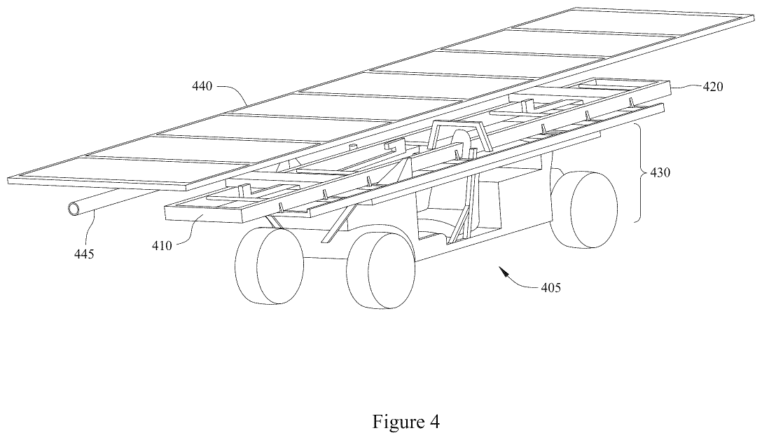

FIG. 4 illustrates a perspective view of a solar table supported by multiple collapsible manipulators in a mobile transport according to various embodiments of the present invention. This mobile transport 405 comprises a first collapsible manipulator 410, a second collapsible manipulator 420 and a transport component 430 that can securely move a solar table 440 to an installation point. In this example, the first collapsible manipulator 410 and the second collapsible manipulator 420 are coupled to a torque tube 445 and provide at least vertical movement of the solar table 440 that has multiple solar panels. In certain embodiments, the first and second collapsible manipulators 410/420 comprise multiple motors to enable at least vertical movement of the solar table. Movement caused by the first collapsible manipulator 410 and movement caused by the second collapsible manipulator 420 may operate at least partially independent of each other to enable angular control, e.g., a pitch angle control, of the torque tube and/or solar table. This angular control (as well as the horizontal and vertical movements) allows a dynamic alignment process of the torque tube 445 within the installation site. According to various embodiments, the horizontal, vertical and angular motion of the torque tube 445 may be motorized or controlled by personnel by applying force to the torque tube 445 or other component(s) on the solar table.

The collapsible manipulators 410 and 420 may be located above and securely coupled to the transport component 430. The collapsible manipulators 410 and 420 may also be an extension to transport component 430. The collapsible manipulators 410 and 420 comprise a plurality of attaching elements that securely attach to the solar table 440.

The transport component 430 comprises a vehicular segment that can move throughout a solar system construction site under the control of a driving system. Examples of the vehicular segment include a wheel system, tractor system and/or robotic movement system to move a solar table from a factory to an installation point. The transport component 430 comprises a driving system that effectively controls the movement of the mobile transport as it carries a solar table from a centralized factory to an installation site. Examples of a driving system include systems that are controlled by an in-vehicle driver, a remote control being used by personnel or an autonomous driving system. If an autonomous driving system is employed, the transport component 430 comprises autonomous driving capabilities which include both a vehicle location element (such as a GPS location, autonomous sensor and image processing, and/or virtual construction site map including roads between factories and installation sites). One skilled in the art will recognize that the transport component 430 may be modified and/or supplemented with a variety of structural and functional elements to further assist in the transportation of solar tables within a solar system construction site.

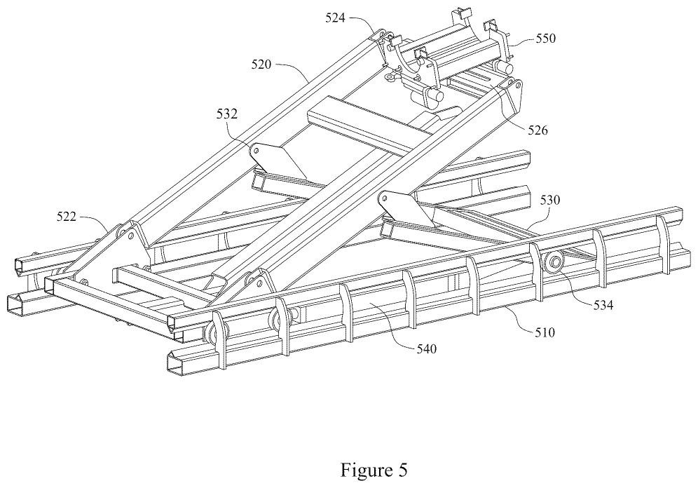

FIG. 5 illustrates a perspective view of a collapsible manipulator according to various embodiments of the invention. In this example, the collapsible manipulator is a scissor lift comprising a base frame 510 attached to the transport component 430, a lift frame 520, a pivot frame 530, a lift control element 540, and a solar table holder 550. The lift frame 520 has a first end 522 pivotably coupled to the base frame 510 and has a support beam 526 placed on a second end 524 of the lift frame 520. The pivot frame 530 has a first end 532 pivotably coupled to the lift frame 520 at a position between the first end and the second end of the lift frame 520. The lift control element 540 couples between a second end 534 of the pivot frame 530 and the first end 522 of the lift frame 520. The lift control element 540 can retract or expand such that the lift frame 520 may be unfolded to a lifted position or be folded to a collapsed position. The solar table holder 550 is attached to the support beam 526 of the lift frame 520 to support a solar table. The solar table holder 550 may comprise one or more solar table securing clamps, such as end effectors, to securely hold a variety of different shapes and types of solar tables.

In one or more embodiments, the solar table holder 550 may be attached to the support beam 526 with a fixed angle. The fixed angle is determined for a leveled support for the solar table only when the lift frame 520 is completely unfolded. Alternatively, the solar table holder 550 may be rotatably attached to the support beam 526 such that solar table holder 550 may remain in a level position to support the solar table during a folding or unfolding process of the lift frame 520. Such a rotatable attachment provides not only a flexibility for a lifted position but also a capacity for adjusting solar table pitch angle (one side of a solar table may be lifted higher than the other side).

The solar table holder 550 may slide along the support beam 526 via a manual or motorized motion, with a sliding range defined by a length of the support beam 526 or a motor traveling distance. Sliding of solar table holders on both collapsible manipulators 410 and 420 may be independent or coordinated. Accordingly, the solar table may be moved horizontally (when the solar table is sliding in synchronization along the collapsible manipulators 410 and 420) or be adjusted in a yaw angle (when the solar table is sliding differentially along the collapsible manipulators 410 and 420), or a combination of both. For example, the support beam 526 may have a line of holes; the solar table holder 550 may slide along the support beam 526 to a desired position (hole) and be securely attached via a pin to the support beam 526. Furthermore, the solar table holder 550 may slide longitudinally, besides sliding along the slide along the support beam 526, and have yaw adjustment capability. Such longitudinal placement and yaw adjustment may be actuated manually, electrically, hydraulically, and/or pneumatically. For example, the solar table holder 550 may comprise a holder base slidably attached to the support beam 526 and a main body that is rotatable and/or longitudinally slidable with respect to the holder base to enable longitudinal placement and yaw adjustment.

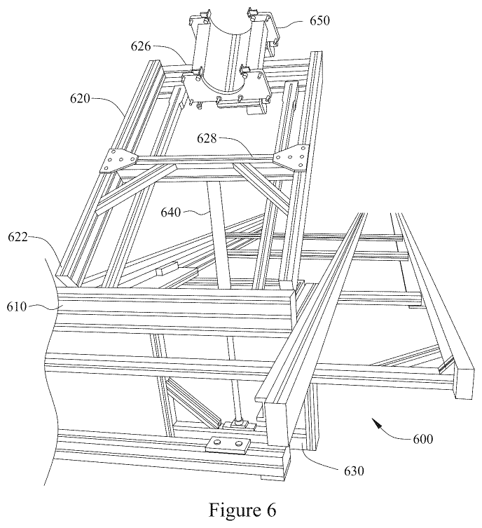

FIG. 6 illustrates a perspective view of an alternative collapsible manipulator according to various embodiments of the invention. In this example, the collapsible manipulator is a direct lift 600 comprising a base frame 610 attached to the transport component 430, a lift frame 620, a lift control element 640, and a solar table holder 650. The direct lift 600 may replace the collapsible manipulators 410 and 420 and be fitted in a mobile transport. The lift frame 620 has a first end 622 pivotably coupled to the base frame 610 and has a support beam 626 placed on a second end 624 of the lift frame 620. Different from the scissor lift shown in FIG. 5, the lift control element 640 couples directly to the lift frame 620 for folding/unfolding the lift frame 620. In this example, the lift control element 640 couples between a horizontal beam 628 of the lift frame 620 and an underneath beam 630 placed underneath the base frame 610. The horizontal beam 628 is between the first end 622 and the support beam 626. With such a layout, the lift control element 640 may be positioned vertically (instead of horizontally as the lift control element 540) and thus avoid intruding into a driver space for the mobile transport. Furthermore, since the lift control element 640 acts on the horizontal beam 628 instead of the support beam 626, the lift control element 640 does not require a long working distance to raise the lift frame 620 to an extended position. The solar table holder 650 is attached to the support beam 626 of the lift frame 620 to support a solar table. Similar to the solar table holder 550, the solar table holder 650 may slide along the support beam 626 via a manual or motorized motion, and may slide longitudinally (besides sliding along the slide along the support beam 626) and have yaw adjustment capability.

The lift control element 540 or 640 may be cylinders, actuators, tracks, etc. that can produce linear motion to fold/unfold the lift frames. For example, the lift control element 540 or 640 are hydraulically, or pneumatically operated cylinders that may be controlled for a desired motion speed and traveling distance for a desired unfolding height for the lift frames (thus the height for the solar table). The solar table holder 550 or 650 may function as an interface to a torque tube for capturing and manipulating a solar table during transport and installation.

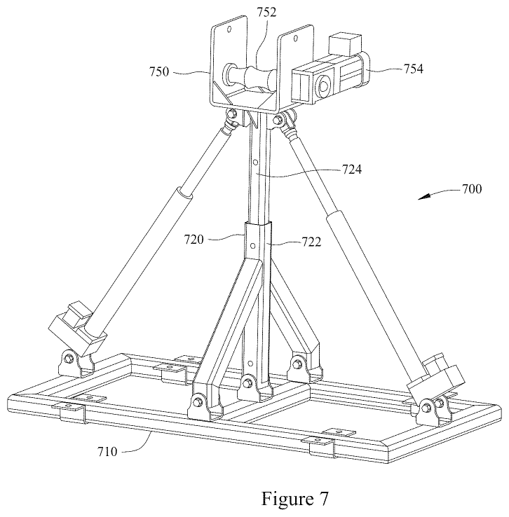

FIG. 7 illustrates a perspective view of another alternative collapsible manipulator according to various embodiments of the invention. In this example, the collapsible manipulator is a pivot lift 700 comprising a base frame 710, a lift frame 720, a pair of lift control elements 730 and 740, and a solar table holder 750. Different from the lift frame in a scissor lift or a direct lift, the lift frame 720 is extendable. As shown in FIG. 7, the lift frame 720 comprises a first section 722 attached to the base frame 710 and a second section 724 slidably coupled to the first section 722. The first section 722 may comprise a plurality of holes that are used to securely lock the second section 724 via a pin once the second section 724 slides to a desired position.

The solar table holder 750 is placed on a top end of the second section 724. In this example, the solar table holder 750 is a U-shaped bracket with a roller 752 placed near a bottom of the bracket such that a torque tube may be placed on the roller and contained within the bracket. In one or more embodiments, the roller may be powered by a motor 754 attached to the bracket such that the roller may be rotated to convey the torque tube forward or backward longitudinally. In one or more embodiments, the solar table holder 750 may be rotatable with respect to the second section 724 such that a torque tube supported by the solar table holder 750 may be adjusted in yaw angle if necessary.

The pair of lift control elements 730 and 740 couple between the base frame 710 and the second section 724 (or the solar table holder 750). As shown in FIG. 7, the lift control element 730 and 740 are placed symmetrically on both sides of the lift frame 720 for a balanced and smooth lifting operation. The lift control element 730/740 and the lift frame 720 may be placed on a same plane for a compact and space-saving layout. As with the lift control element shown in FIGS. 5 and 6, the lift control element 730 and 740 may be hydraulically, or pneumatically operated cylinders that may be controlled for a desired motion speed and traveling distance for a desired lifting height for the solar table holder 750.

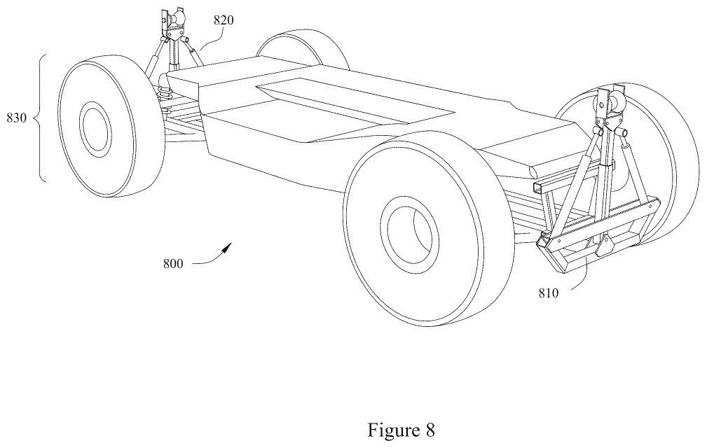

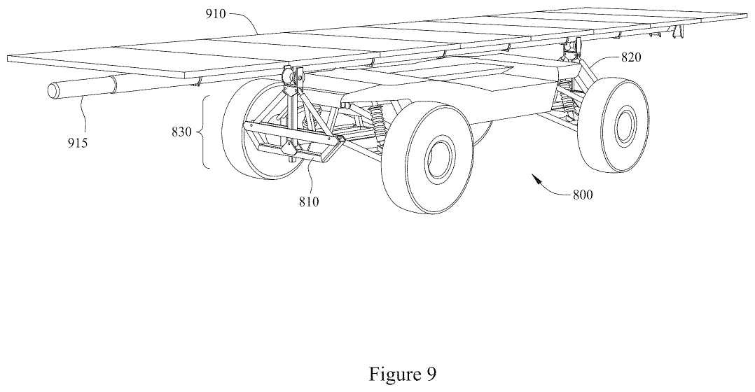

FIG. 8 and FIG. 9 respectively illustrate a perspective view of a pair of pivot lifts on a mobile transport without or with a solar table load according to various embodiments of the present invention. This mobile transport 800 comprises a first collapsible manipulator (pivot lift) 810, a second pivot lift 820 and a transport component 830 that can securely move a solar table 910. The first and the second pivot lifts 810/820 may be controlled to shift laterally independently or collaboratively with respect to the transport component 830. As shown in FIG. 9, the first pivot lift 810 and the second pivot lift 820 are coupled to a torque tube 915 and are able to provide at least vertical movement of the solar table 910. Movement caused by the first pivot lift 810 and movement caused by the second pivot lift 820 may operate collaboratively or independently to enable one or more movements, e.g., a vertical movement, a longitudinal movement, a pitch angle adjustment, a yaw angle adjustment, and/or a lateral (traverse) shift, for the torque tube and thus the solar table.

The pivot lifts 810 and 820 may have their base frames installed at a low position, e.g., underneath the transport component 830. The pivot lifts 810 and 820 may have their base frames orientated vertically such that the base frame of each pivot lift may be placed in a same plane as the lift control elements and the lift frame. Such a coplanar layout makes the mobile transport very compact lengthwise. As a result, the mobile transport is easier to maneuver. For example, the mobile transport may lift the solar table to a higher above pile line. Given the compactness of the mobile transport itself, the mobile transport may be easily maneuvered between piles to a desired position for solar table installation.

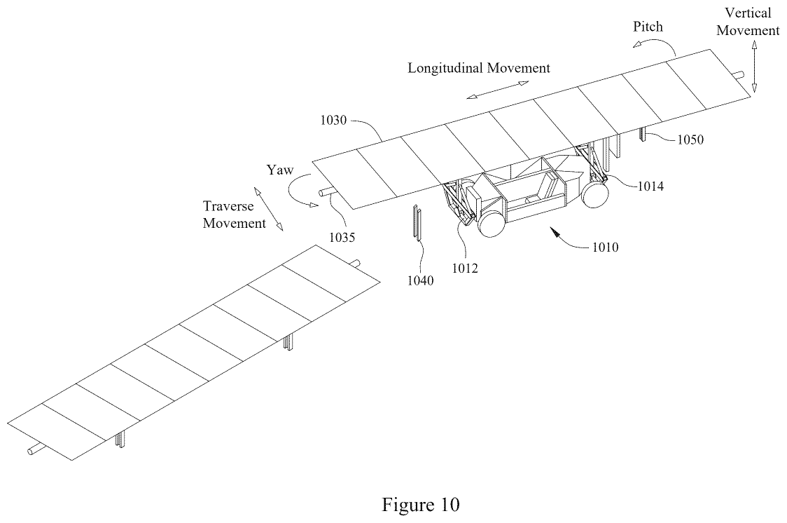

FIG. 10 is a diagram illustrating a mobile transport rotating a solar table for installation according to various embodiments of the invention. As shown in the Figure, a mobile transport 1010 supporting a solar table 1030 approaches a point of installation. The solar table 1030 comprises a torque tube 1035 that is securely supported by the mobile transport 1410 via a first and a second collapsible manipulators 1012/1014, which may be scissor lifts, direct lifts, or pivot lifts as described in FIGS. 5-7.

During the transportation of the solar table 1030, the collapsible manipulators 1012/1014 may be collapsed completely or just partially expanded to lower the center of gravity for driving stability. Once the mobile transport 1010 approaches an installation spot, e.g., a location between installation piles 1040 and 1050, the mobile transport 1010 lifts the solar table 1030 by unfolding the collapsible manipulators 1012/1014 such that that solar table may cross the piles from above and the mobile transport 1010 can maneuver between the installation piles 1040 and 1050. The compactness of the mobile transport 1010, especially when the collapsible manipulators 1012/1014 are vertically placed as shown in FIG. 8-9, greatly enhances the maneuverability of the mobile transport 1010 within the limited space between the piles 1040 and 1050.

The collapsible manipulators 1012 and 1014 are height-adjustable with each manipulator operating independently or collaboratively such that the solar table 1030 may be raised, lowered, and/or adjusted in a pitch angle. In one or more embodiments, the solar table 1030 may be moved horizontally and/or adjusted in a yaw angle by sliding solar table holders along corresponding support beams, as shown in FIGS. 5-6. Such a combination of solar table movement capability delivers superior flexibility for the mobile transport 1010. Precise parking of the mobile transport relative to installation piles is no longer required. The mobile transport just needs to be parked in proximity to an installation spot, e.g., just between piles 1040 and 1050 without a precise alignment with the piles.

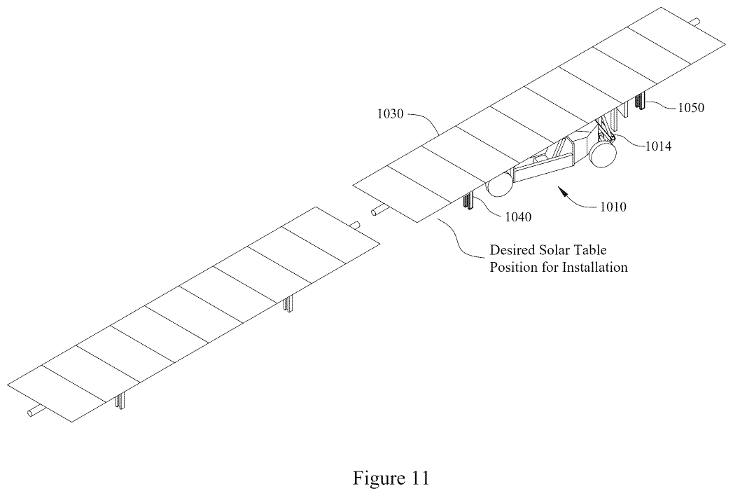

Additionally, the mobile transport may be able to overcome various environmental obstacles, e.g., uneven ground, limited parking space at an installation spot, etc. With one or more movements, e.g., height adjustment, pitch angle adjustment, horizontal movement, etc., the solar table 1030 may be aligned to an installation instance ready for installation, as shown in FIG. 11.

The mobile transport 1010 may align the solar table 1030 to the installation stance with one or more movements, e.g., raising or lowering a height, adjusting a pitch angle, and/or adjusting a roll angle, etc. The maneuvering of the solar table may be implemented based on one or more parameters, such as an installation height for the solar table, a designed X-Y orientation of the solar table, ambient environment information of the point of installation, etc. The ambient environment information, such as a ground slope or a ground tilt at the point of installation may be obtained via on-board sensors (e.g., level sensors) in the mobile transport. The ground slope and/or the ground tilt may be compensated when the mobile transport 1010 aligns the solar table 1030 to the installation stance. In one or more embodiments, the mobile transport may use various coordinate systems, such as Cartesian coordinates, polar coordinates, delta coordinates, robot arm coordinate, etc., for solar table alignment. Once the solar table is maneuvered to the installation stance, the solar table is unloaded from the mobile transport for installation.

One skilled in the art will recognize that a solar table may have a variety of different support structures such as beams, purlins, etc., that either supplement or replace a torque tube. All of these different solar type examples are intended to fall within the scope of certain embodiments of the invention and the different ways in which the solar table is coupled to the mobile transport is intended to fall within the scope of certain embodiments of the invention.

One skilled in the art will recognize that the different movements supported by the mobile transport support robust alignment processes that allow for a more efficient and accurate alignment of a solar table to a corresponding mounting structure. In some embodiments, the alignment process(es) may be performed manually by personnel at the installation site that control each of the motors during alignment. In other embodiments, the alignment process(es) may be automatically performed by sensors and motor controls such that motor movement is controlled by computerized analysis of sensor data and/or image data. A variety of sensor technologies may be employed by a mobile transport such as LiDAR, camera sensors, radar sensors and other sensor technologies known to one of skill in the art. Furthermore, active and passive sensor systems may also be deployed.

In certain examples, detachable sensor systems may be positioned on a solar table (such as on a torque tube) prior to or during installation of the solar table. The detachable sensor device/system may be removed from the solar table once installation is complete and positioned on another table that needs to be installed within the system. In other examples, the alignment process may comprise both manual and automated processes that result in the installation of a solar panel within the system.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A mobile transport for moving a solar table, the mobile transport comprising:
a transport component operable to move the solar table from a first location to a point of installation; and
a first and a second collapsible manipulators, each collapsible manipulator comprises a base frame coupled to the transport component and a solar table holder that couples to a torque tube of the solar table, the first and the second collapsible manipulators are collapsible to raise or lower the solar table holder.

2. The mobile transport of claim 1 wherein the first and the second collapsible manipulators operate independently from each other or collaboratively.

3. The mobile transport of claim 2 wherein each collapsible manipulator is a scissor lift comprising:
a lift frame having a first end pivotably coupled to the base frame and having a support beam placed on a second end of the lift frame, the solar table holder is attached to the support beam to support the solar table;
a pivot frame having a first end pivotably coupled to the lift frame at a position between the first end and the second end of the lift frame; and
a lift control element coupled between a second end of the pivot frame and the first end of the lift frame, the lift control element is operable to unfold the lift frame to a lifted position or folded the lift frame to a collapsed position.

4. The mobile transport of claim 3 wherein the solar table holder is slidable along the support beam such that the mobile transport is able to move the solar table horizontally or adjust a yaw angle of the solar table.

5. The mobile transport of claim 3 wherein the lift control element is a hydraulically or pneumatically operated cylinder that is controllable for a desired motion speed and a traveling distance.

6. The mobile transport of claim 2 wherein each collapsible manipulator is a direct lift comprising:
a lift frame having a first end pivotably coupled to the base frame, the lift frame comprises a support beam placed on a second end of the lift frame and a horizontal beam placed between the first end and the support beam, the solar table holder is slidably attached to the support beam to support the solar table; and
a lift control element coupled between the support beam of the lift frame and an underneath beam placed underneath the base frame, the lift control element is operable to unfold the lift frame to a lifted position or folded the lift frame to a collapsed position.

7. The mobile transport of claim 6 wherein the lift control element is positioned vertically.

8. The mobile transport of claim 3 wherein each collapsible manipulator is a pivot lift comprising:
a lift frame comprises a first section attached to the base frame and a second section slidably coupled to the first section, the solar table holder is placed on a top end of the second section; and
a pair of lift control elements coupled between the base frame and the second section, the pair of lift control elements are placed symmetrically on both sides of the lift frame for a balanced layout and are operable to lift the second section to a lifted position or lower the second section to a collapsed position.

9. The mobile transport of claim 8 wherein the solar table holder is a U-shaped bracket with a roller placed near a bottom of the U-shaped bracket to support the torque tube, the roller is powered by a motor attached to the U-shaped bracket for roller rotation to convey the torque tube forward or backward.

10. The mobile transport of claim 8 wherein each of the pair of lift control elements is a hydraulically or pneumatically operated cylinder that is controllable for a desired motion speed and a traveling distance.

11. The mobile transport of claim 8 wherein the pair of lift control elements, the lift frame, and the base frame are placed in a coplanar layout for a lengthwise compactness of the mobile transport.

12. A method for moving a solar table, the method comprising:
loading the solar table on to a mobile transport at a first location, the mobile transport comprises a transport component and a pair of collapsible manipulators, each collapsible manipulator comprises a base frame coupled to the transport component and a solar table holder that couples to a torque tube of the solar table, the pair of collapsible manipulators are collapsible to raise or lower the solar table holder;
operating the pair of collapsible manipulators for a collapsed or a partially expanded position for driving stability;
transporting, by the mobile transport, the solar table from the first location to a point of installation; and
aligning the solar table to an installation stance.

13. The method of claim 12 wherein the pair of collapsible manipulators operates independently from each other or collaboratively.

14. The method of claim 12 wherein each collapsible manipulator is a scissor lift comprising:
a lift frame having a first end pivotably coupled to the base frame and having a support beam placed on a second end of the lift frame, the solar table holder is attached to the support beam to support the solar table;
a pivot frame having a first end pivotably coupled to the lift frame at a position between the first end and the second end of the lift frame; and
a lift control element coupled between a second end of the pivot frame and the first end of the lift frame, the lift control element is operable to unfold the lift frame to a lifted position or folded the lift frame to a collapsed position.

15. The method of claim 12 wherein each collapsible manipulator is a direct lift comprising:
a lift frame having a first end pivotably coupled to the base frame, the lift frame comprises a support beam placed on a second end of the lift frame and a horizontal beam placed between the first end and the support beam, the solar table holder is slidably attached to the support beam to support the solar table; and
a lift control element coupled between the support beam of the lift frame and an underneath beam placed underneath the base frame, the lift control element is operable to unfold the lift frame to a lifted position or folded the lift frame to a collapsed position.

16. The method of claim 12 wherein each collapsible manipulator is a pivot lift comprising:
a lift frame comprises a first section attached to the base frame and a second section slidably coupled to the first section, the solar table holder is placed on a top end of the second section; and
a pair of lift control elements coupled between the base frame and the second section, the pair of lift control elements are placed symmetrically on both sides of the lift frame for a balanced layout and are operable to lift the second section to a lifted position or lower the second section to a collapsed position.

17. The method of claim 16 wherein the base frame is placed at a position underneath the transport component.

18. The method of claim 16 wherein the pair of lift control elements, the lift frame, and the base frame are coplanar for lengthwise compactness of the mobile transport.

19. The method of claim 12 wherein transporting, by the mobile transport, the solar table from the first location to the point of installation comprises:
transporting the solar table from the first location in proximity to the point of installation, the point of installation is between two piles;
lifting the solar table by unfolding the collapsible manipulators such that that solar table is able to cross the two piles from above;
maneuvering the mobile transport between the two piles to the point of installation.

20. The method of claim 12 wherein aligning the solar table to the installation stance comprises one or more of:
raising or lowering a height of the solar table;
moving the solar table horizontally;
moving the solar table laterally;
moving the solar table longitudinally;
adjusting a pitch angle of the solar table; and
adjusting a yaw angle of the solar table.
